(19) United States
(12) Patent Application Publication
(10) Pub. No.: US 2011/0269339 A1
(43) Pub. Date: Nov. 3, 2011

(54) SYSTEM FOR SECURING A DEVICE USING TWO DIN RAILS

(75) Inventor: Michael S. Baran, Milwaukee, WI (US)

(73) Assignee: Rockwell Automation Technologies, Inc., Mayfield Heights, OH (US)

(21) Appl. No.: 12/771,855

(22) Filed: Apr. 30, 2010

(51) Int. Cl. H01R 13/60

(52) U.S. Cl. 439/532

(57) ABSTRACT

A system for securing a device to first and second DIN rails is provided. The system includes a static attachment structure configured to secure the device to the first DIN rail and a movable attachment structure configured to secure the device to the second DIN rail. The movable attachment structure includes a carrier secured to the device and a latch secured to the carrier and configured to engage the device to the second DIN rail in a latched position.

### BACKGROUND

The invention relates generally to rail mounted devices, and particularly to a system for securing devices using two rails.

Various systems are known and are in use for mounting devices on panels and in enclosures. One way of mounting such devices is through the use of rails that have inwardly or outwardly projecting flanges along their length for receiving the devices such as terminal strips, input/output modules, small motor drives, circuit breakers and so forth within systems such as employed for industrial control applications. Such rails are commonly referred to as “DIN” rails (a name derived from the acronym for Deutsches Institute fur Normung, a German standards-setting organization), and have become a quasi-standard in many industrial and other settings. Such DIN rails are typically attached to a panel wall via tapped holes, which do not require precision positioning. The devices, in turn, are required to have features that mate to the DIN rail profile.

Typically, such devices are mounted to a single DIN rail such as the standard 35 mm×15 mm top hat DIN rail, which is typically pre-attached to the panel. However, such DIN rails have limited load and moment bearing capacity and are not designed for or able to support relatively heavy/large devices.

Another mounting technique involves mounting the devices directly on the panel by drilling a large number of holes, which may be required to be substantially precisely positioned. Such positioning may be achieved using techniques such as pre-drilling, templates and spotting with the actual devices to be mounted. The resulting system is, however, inherently less flexible and more difficult to service should there be a need to remove the devices.

In certain systems, two DIN rails may be utilized to mount large/heavy devices. The device interface may be required to have two parallel slots rigidly fixed from each other. As a result, precision placement of the DIN rails may be required on the panel so that the devices can locate and secure to their flanges accurately. However, such techniques are not only time consuming to use, but may also result in inaccurate alignment/positioning of the device along with the DIN rails, leading to additional time and effort to correct any alignment errors that make the devices insecure or prone to detachment from the rails.

Accordingly, it would be desirable to develop a system for securing large devices using DIN rails while controlling the overall position of such devices.

### BRIEF DESCRIPTION

Briefly, according to one embodiment of the present invention, a system for securing a device to first and second DIN rails is provided. The system includes a static attachment structure configured to secure the device to the first DIN rail and a movable attachment structure configured to secure the device to the second DIN rail. The movable attachment structure includes a carrier secured to the device and a latch secured to the carrier and configured to engage the device to the second DIN rail in a latched position.

In accordance with another aspect, a system for securing a device to upper and lower DIN rails is provided. The system includes a static attachment structure having a straight lower edge and a hook formed on an upper edge, wherein the hook is configured to secure the device to the upper DIN rail. The system also includes a movable attachment structure having a straight upper edge and a latch disposed on the lower edge, wherein the latch is configured to engage the device to the lower DIN rail in a latched position.

In accordance with another aspect, a system for securing a device to upper and lower DIN rails is provided. The system includes a device and upper and lower DIN rails arranged generally horizontally and parallel to one another and configured to mount the device to a panel. The system also includes a static attachment structure including a hook-like structure configured to secure the device to the upper DIN rail and to support substantially the entire weight of the device and a movable attachment structure configured to secure the device to the lower DIN rail. The movable attachment structure includes a carrier vertically slidably secured to the device and a latch secured to the carrier and configured to engage the device to the lower DIN rail in a latched position.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary system with a device mounted to a panel in accordance with aspects of the present technique.

FIG. 2 is a perspective view of an exemplary configuration of a device enclosure with the device secured using the upper and lower DIN rails.

FIG. 3A is a side view of the device with the static and movable attachment structures in accordance with aspects of the present technique.

FIG. 3B is a more detailed view of the static attachment structure of FIG. 3A in accordance with aspects of the present technique.

FIG. 3C is a more detailed view of the movable attachment structure of FIG. 3A in accordance with aspects of the present technique.

FIG. 4 is a detailed elevational view of the device with the movable attachment structure in accordance with aspects of the present technique.

FIG. 5 is an elevational view of the device enclosure with details of attachment mechanism for the carrier and latch to the enclosure in accordance with aspects of the present technique.

FIG. 6 is a detailed elevational view of the device with another configuration of the movable attachment structure.

FIG. 7 is a perspective view of another exemplary configuration of the device enclosure of FIG. 2 with the device secured using the upper and lower DIN rails.

### DETAILED DESCRIPTION

As discussed in detail below, embodiments of the present technique function to provide a system for securing large devices using two DIN rails. As used herein, the term “DIN rail” refers to a standardized metal rail having a hat-shaped cross-section and is characterized by an elongated channel having opposed coplanar flanges along its length.

Such DIN rails are known in the art for mounting electrical components in panels and are available in standard widths (e.g., 35 mm, 15 mm etc). In particular, the present technique utilizes two horizontal DIN rails for mounting at least one device such as industrial control equipment to a panel inside an equipment rack. Furthermore, static and movable attachment structures are employed to secure the at least one device to the DIN rails.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

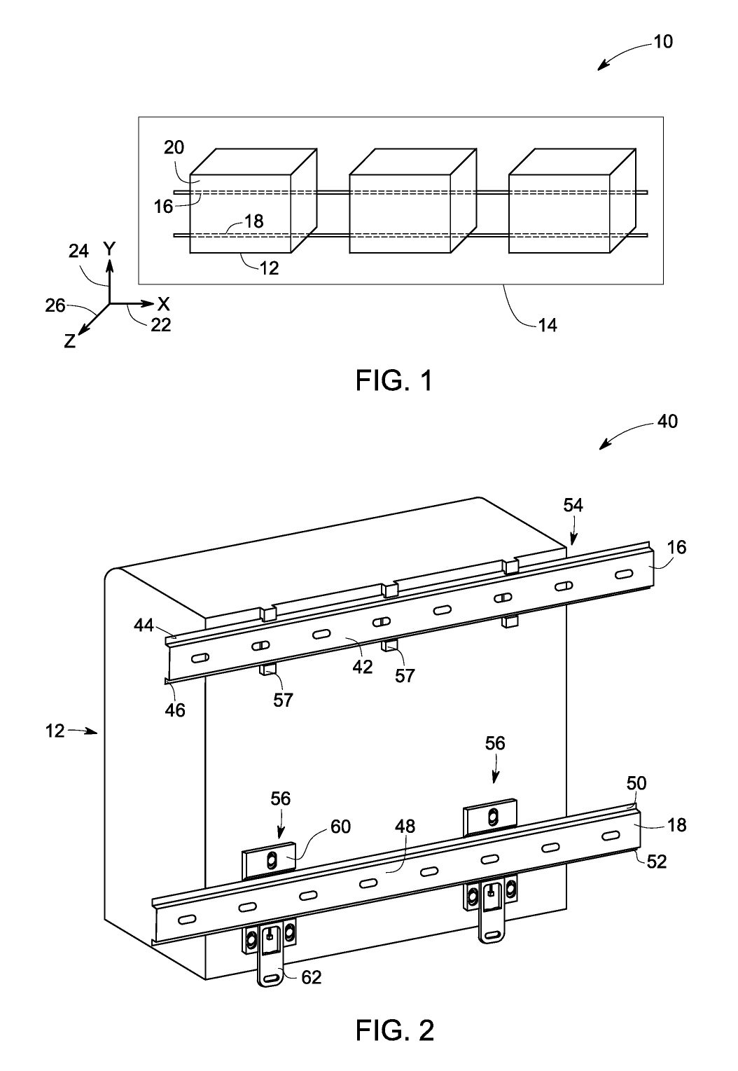

Turning now to the drawings and referring first to FIG. 1 an exemplary system 10 with a device 12 mounted to a panel 14 is illustrated. In one exemplary embodiment, the system 10 includes an industrial control system having a plurality of devices 12 such as programmable logic controllers, variable frequency drives, digital and analog instrumentation mounted to the panel 14. In the exemplary embodiment, the device 12 is secured to the panel using two DIN rails such as represented by reference numeral 16 and 18.

The DIN rails 16 and 18 are arranged generally horizontally and parallel to one another and are configured to mount the device 12 to the panel 14 using attachment structures on a back surface 20 of the device 12. In certain embodiments, the device 12 may be housed within a device enclosure and such enclosure may be secured to the panel 14 via the DIN rails 16 and 18. Exemplary configurations of such attachment structures will be described in detail below.

In certain embodiments, the attachment structures may be mounted on an adaptor plate that is coupled to the back surface 20 of the device 12. Furthermore, the DIN rails 16 and 18 with the device 12 may be supported by rack mount brackets within a rack of an enclosure. Such rack mount brackets may include cable access conduits to facilitate electrical connections of the device 12. In this exemplary embodiment, the attachment structures include static and movable structures for controlling the translation and rotational degrees-of-freedom in the x, y and z-directions generally represented by reference numerals 22, 24 and 26.

FIG. 2 is a perspective view of an exemplary configuration 40 of a device enclosure with the device 12 secured using the upper and lower DIN rails 16 and 18. The upper DIN rail 16 includes a base 42 and flanges 44 and 46 extending outwardly in an inverted L-shape from opposite sides of the base 42. Similarly, the lower DIN rail 18 includes a base 48 and flanges 50 and 52.

In the illustrated embodiment, the device enclosure 40 includes a static attachment structure 54 configured to secure the device 12 to the upper DIN rail 16. In addition, a movable attachment structure 56 is configured to secure the device 12 to the lower DIN rail 18. The static and movable attachment structures 54 and 56 are disposed on a back surface 58 of the device enclosure 40. As will be appreciated by those skilled in the art, the static and movable attachment structures 54 and 56 may be interchangeably utilized at top and bottom surfaces of the enclosure 40 to secure the device 12 to the upper and lower DIN rails 16 and 18.

In this exemplary embodiment, the static movable attachment structure 54 includes a plurality of attachment structures such as represented by reference numerals 57 for securing the device 12 to the upper DIN rail 16. Such structures 57 may engage attachment mechanisms such as hooks and stop structures that are well known in the art for securing the device 12 to the DIN rail 16.

In the illustrated embodiment, the movable attachment structure 56 includes a carrier 60 secured to the device enclosure 40 and a latch 62 secured to the carrier 60. The latch 62 is configured to engage the device 12 to the lower DIN rail 18 in a latched position. In this exemplary embodiment, the latch 62 includes coil springs. In certain embodiments, the latch 62 is based upon positional bistability of a spring-like material such as spring steel, plastic etc. In this exemplary embodiment, the device 12 is secured to the lower DIN rail 18 using two movable attachment structures 56. However, the number of such structures may be lesser or more based upon a weight of the device 40.

In this exemplary embodiment, the static attachment structure 54 is configured to support substantially the entire weight of the device 12. Further, the static and movable attachment structures 54 and 56 cooperate to resist a moment or applied translational force (e.g. mechanical shock or seismic forces) tending to remove the device 12 from the upper and lower DIN rails 16 and 18.

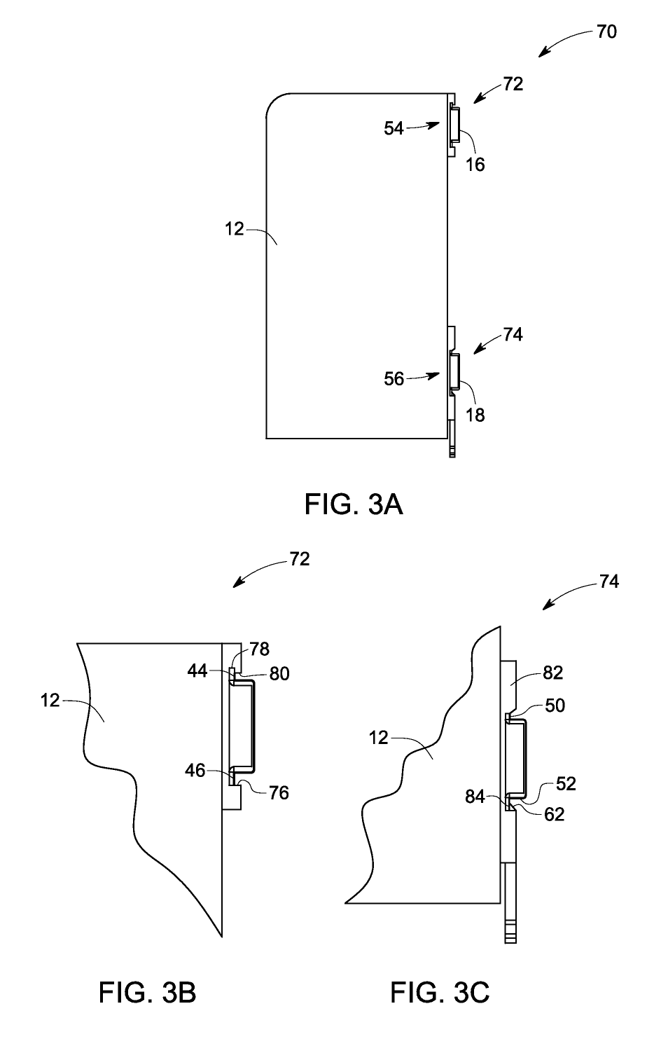

FIG. 3A is a side view 70 of the device 12 with the static and movable attachment structures 54 and 56. As illustrated, the static attachment structure 54 includes a plurality of channels such as represented by reference numeral 72 in a pre-determined fixed position to secure the device 12 to the upper DIN rail 16. Further, the movable attachment structure 56 includes a channel 74 with a pre-defined allowed translation in the y-direction 24 (see FIG. 1). Advantageously, the combination of the static and movable attachment structures 54 and 56 facilitate alignment of loosely positioned DIN rails 16 and 18 while providing substantial control of five degrees of freedom.

FIGS. 3B and 3C are detailed views of the channels 72 and 74 respectively. In the illustrated embodiment, the channel 72 includes a straight lower edge 76 and a hook 78 formed on an upper edge 80. The hook 78 is configured to secure the device 12 to the flange 44 of the upper DIN rail 16 while the flange 46 is supported by the straight lower edge 76. Moreover, the channel 74 includes an upper straight edge 82 and the latch 62 disposed on a lower edge 84. The latch 62 is configured to engage the device 12 to the flange 52 of the lower DIN rail 18 in a latched position and the flange 50 is supported by the upper straight edge 82. In one exemplary embodiment, the latch 62 may include one or more simple coil springs to hold the latch 62. In another exemplary embodiment, the latch 62 includes a bistable latch.

In one exemplary embodiment, a height of the static attachment structure 54 is substantially the same as the width of the upper DIN rail 16 to control a translation degree of freedom in the y-direction 24. Moreover, a translation degree of freedom in the z-direction 26 is controlled by the hook 78 of the static attachment structure 54 and the latch 62 of the movable attachment structure 56. In one exemplary embodiment, a rotational degree of freedom in the y- and z-directions 24 and 26 are controlled by the width of each of the static attachment structures 54 or by the distance between them. Moreover, the rotational degree of freedom in the x direction 22 is controlled by adjusting dimensions of the hook 78 and the latch 62.

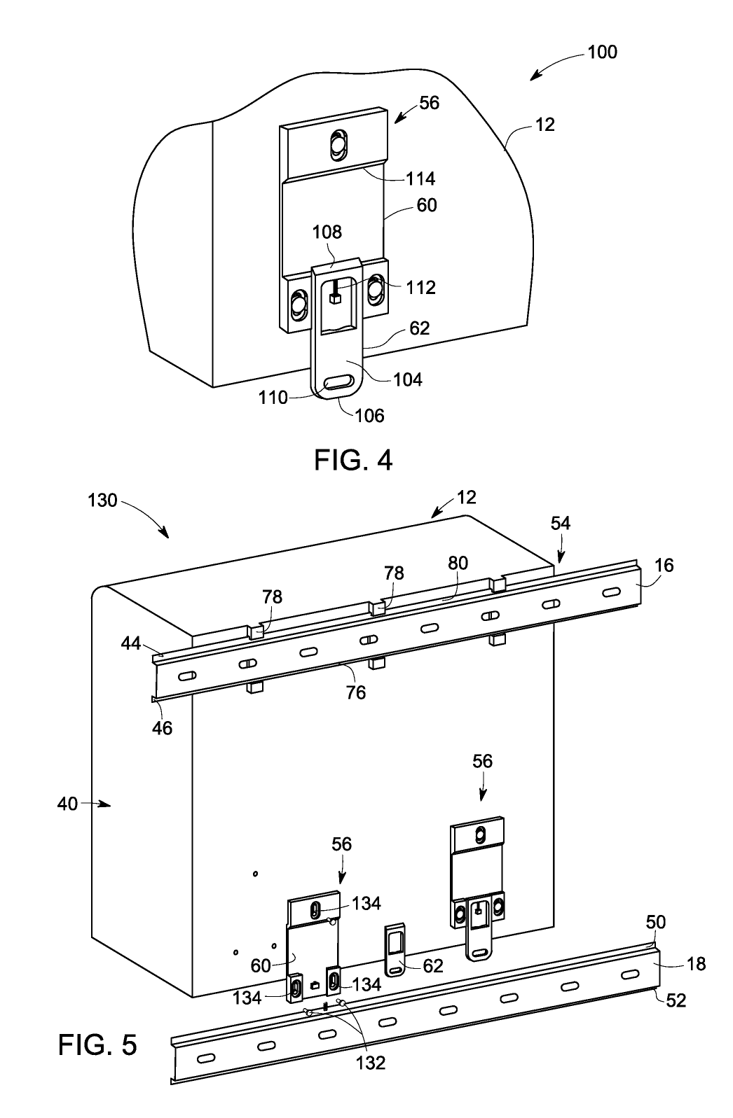

FIG. 4 is a detailed elevational view 100 of the device 12 with the movable attachment structure 56. As illustrated, the movable attachment structure 56 includes the latch 62 secured to the carrier 60. The carrier 60 is configured to slide vertically with respect to the device 12 and device enclosure 40. As described before, the latch 62 is configured to secure the device 12 to the lower DIN rail 18.

In certain embodiments, the latch 62 is formed from a flexible plastic material, such as an acetal, available from Hoechst Celanese Corporation, Dallas, Tex., under the trade name CELCON™, although any suitable material may be used The latch 62 has a generally rectangular body 104 with one end 106 extending past an edge of the device 12 and another end 108 engaging the flange 52 of the lower DIN rail 18.

A slot 110 formed in the end 106 is configured to receive a screw driver tip for prying the latch 62 downwardly to release the device 12 from the lower DIN rail 18. In certain embodiments, with a bistable latch configuration, the slot 110 may be utilized for closing the latch 62 from an open position. In this exemplary embodiment, the end 108 includes a beveled edge that facilitates downward movement of the latch 62 when pressure is applied to the device 13 for mounting to the DIN rail 18. In the illustrated embodiment, the latch 62 includes coil spring 112 formed as an integral part of the body 104. In another exemplary embodiment, the latch may include a pair of opposing springs 112 that may have an arcuate shape, although other configurations may be used.

In this exemplary embodiment, the movable structure 56 is configured to remain in sliding engagement with the device 12 prior to and after the latch 62 is in the latched position. In operation, the latch 62 is configured to engage the lower DIN rail 18 between a surface of the end 108 and an upper abutment surface 114 of the carrier 60. The ability of the structure to move may greatly aid in allowing the device to be attached to both DIN rails, while accommodating some misalignment or imprecise parallelism between the rails. That is, the more fixed or rigid structure on the top of the device for attachment to the upper rail may define the vertical position of the device on the panel, while the lower movable structure aids in supporting the device, while nevertheless allowing some freedom of movement of the lower support structure with respect to the upper structure.

In certain embodiments, the device 12 may include a plurality of movable attachment structures 56 along the width of the device 12. In one exemplary embodiment, the number of the movable attachment structures is based upon the weight of the device 12. Further, each of the plurality of movable attachment structures 56 may include an independently slidable carrier 60 secured to a respective latch 62.

FIG. 5 is an elevational view 130 of the device enclosure 40 with details of attachment mechanism for the carrier 60 and latch 62 to the enclosure 40. As illustrated, the device 12 is secured to the upper DIN rail 16 via the edge 76 and hooks such as represented by reference numeral 78 formed on the upper edge 80 of the static attachment structure 54. Further, the device 12 is secured to the lower DIN rail 18 via the latch 62 of the movable attachment structure 56.

In the illustrated embodiment, the carrier 60 is vertically slidably secured to the device 12 within the slot 102 using fasteners such as represented by reference numeral 132. In the illustrated embodiment, the carrier includes a plurality of slots such as represented by reference numeral 134 for slidably retaining the fasteners 132 to the device 12. In this exemplary embodiment, the slots 134 include oval or racetrack shaped slots. However other configurations of the slots 134 may be envisaged. As will be appreciated by those skilled in the art, a variety of other securing mechanisms may be employed for slidably securing the carrier 60 to the device 12.

Further, the latch 62 is secured to the carrier 60. In operation, the latch 62 engages the device 12 to the lower DIN rail 18. In certain embodiments, the upper and lower DIN rails 16 and 18 are coupled to a panel such as the panel 14 of FIG. 1 via a plurality of screws. It should be noted that each of the plurality of screws in such configuration has a relatively high load bearing capacity than the screws of an assembly having the device 12 supported by a single DIN rail.

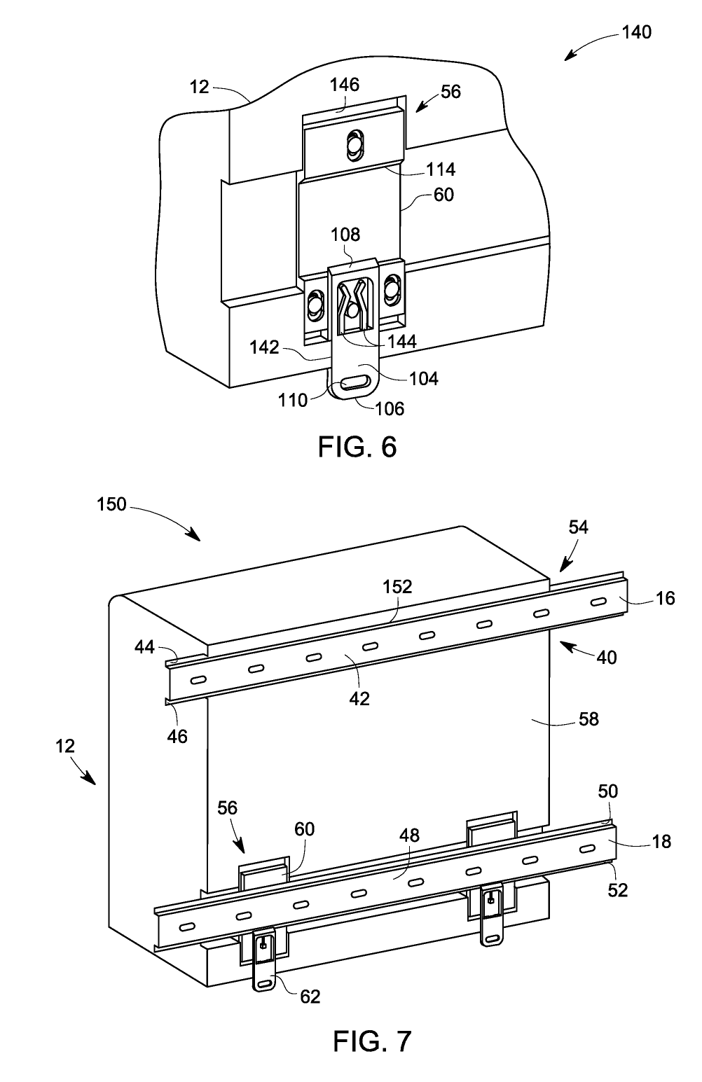

FIG. 6 is a detailed elevational view 140 of the device 12 with another configuration of the movable attachment structure 56. In this exemplary embodiment, the movable attachment structure 56 includes a bi-stable latch 142 secured to the carrier 60. As illustrated, the latch 142 includes pair of opposing springs 144 to facilitate engagement of the device 12 with the lower DIN rail 18 in a latched position. In this exemplary embodiment, the carrier 60 is configured to slide within a slot 146 having pre-determined height to substantially accommodate variations in distance and parallelism between the upper and lower DIN rails 16 and 18. In certain embodiments, the device 12 may include a plurality of independently slidable carriers 60 secured to a respective latch 142.

FIG. 7 is a perspective view of another exemplary configuration 150 of the device enclosure 40 of FIG. 2 with the device 12 secured using the upper and lower DIN rails 16 and 18. In this exemplary embodiment, the static attachment structure 54 includes a single structure having a straight lower edge and a hook 152 formed on an upper edge. The hook 152 is configured to secure the device 12 to the upper DIN rail 16. Again, the movable attachment structure 56 includes the carrier 60 with the latch 62 secured to the device enclosure 40 and configured to engage the device 12 to the lower DIN rail 18.

The various aspects of the structures described hereinabove may be used for securing devices such as drives, smart motor controls, soft starters, distribution blocks, routers and power supplies to panels/enclosures such as those typically found in industrial control centers and other systems. As described above, the technique utilizes attachment structures to secure the device using two DIN rails. As will be appreciated by those skilled in the art, the use of static and movable attachment structures described above allows use of two DIN rails to effectively support the entire weight and moment of larger/heavier devices. The technique accommodates relatively imprecise positioning of the DIN rails while controlling the overall position of the device.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for securing a device to first and second DIN rails, the system comprising:
a static attachment structure configured to secure the device to the first DIN rail; and
a movable attachment structure configured to secure the device to the second DIN rail, the movable attachment structure comprising a carrier secured to the device and a latch secured to the carrier and configured to engage the device to the second DIN rail in a latched position.

2. The system of claim 1, wherein the movable attachment structure is mounted on a back surface of a device enclosure.

3. The system of claim 2, wherein the carrier is configured to slide vertically with respect to the device enclosure.

4. The system of claim 3, wherein the carrier is configured to slide within a slot having pre-determined height to substantially accommodate variations in distance and parallelism between the first and second DIN rails.

5. The system of claim 1, wherein the static attachment structure is configured to support substantially the entire weight of the device.

6. The system of claim 1, wherein the static and movable attachment structures cooperate to resist a moment tending to remove the device from the first and second DIN rails.

7. The system of claim 1, wherein the static and movable attachment structures cooperate to resist translational forces in y and z directions.

8. The system of claim 1, wherein the movable attachment structure is configured to remain in sliding engagement with the device prior to and after the latch is in the latched position.

9. The system of claim 1, wherein the latch is configured to engage the lower DIN rail between a surface of the latch and an upper abutment surface of the carrier.

10. The system of claim 9, wherein the latch comprises a bistable latch.

11. The system of claim 10, wherein the latch comprises simple springs.

12. A system for securing a device to first and second DIN rails, the system comprising:
a static attachment structure having a straight lower edge and a hook formed on an upper edge, wherein the hook is configured to secure the device to the first DIN rail; and
a movable attachment structure having a straight upper edge and a latch disposed on the lower edge, wherein the latch is configured to engage the device to the second DIN rail in a latched position.

13. The system of claim 12, wherein the latch is mounted on a carrier that is slidably movable on an enclosure of the device.

14. The system of claim 13, wherein the system comprises a plurality of latches mounted on independently slidable carriers along a width of the device.

15. The system of claim 12, wherein a height of the static attachment structure is substantially the same as the width of the first rail to control a translation degree of freedom in a y-direction and wherein a translation degree of freedom in a z-direction is controlled by the hook formed on the static attachment structure and the latch of the movable attachment structure.

16. The system of claim 12, wherein a rotational degree of freedom in a z-direction is controlled by the width of each of the static structure or a distance between multiple static structures and wherein the rotational degree of freedom in y and x directions are controlled by the hook of the static attachment structure and the latch of the movable attachment structure.

17. A system for securing a device to upper and lower DIN rails, the system comprising:
a device;
upper and lower DIN rails arranged generally horizontally and parallel to one another and configured to mount the device to a panel;
a static attachment structure including a hook-like structure configured to secure the device to the upper DIN rail and to support substantially the entire weight of the device; and
a movable attachment structure configured to secure the device to the lower DIN rail, the movable attachment structure comprising a carrier vertically slidably secured to the device and a latch secured to the carrier and configured to engage the device to the lower DIN rail in a latched position.

18. The system of claim 17, wherein the assembly comprises a plurality of movable attachment structures along a width of the device and wherein each of the plurality of movable attachment structures comprises independently slidable carrier secured to a respective latch.

19. The system of claim 18, wherein a number of the static and movable attachment structures is based upon a weight of the device.

20. The system of claim 17, wherein the upper and lower DIN rails are coupled to the panel via a plurality of fasteners and wherein each of the plurality of fasteners has a relatively high load bearing capacity than the screws of the assembly with a single DIN rail.
